(19) United States
(12) Patent Application Publication
(10) Pub. No.: US 2014/0087248 A1
(43) Pub. Date: Mar. 27, 2014

(54) NONAQUEOUS ELECTROLYTE RECHARGEABLE BATTERY

(71) Applicant: DENSO CORPORATION, Kariya-city (JP)

(72) Inventors: Yuuki Tachibana, Chita-gun (JP); Syuuhei Yoshida, Tokoname-city (JP)

(73) Assignee: DENSO CORPORATION, Kariya-city (JP)

(21) Appl. No.: 14/036,370

(22) Filed: Sep. 25, 2013

(30) Foreign Application Priority Data
Sep. 26, 2012 (JP) 2012-213034

(51) Int. Cl. H01M 10/0567; H01M 10/0525

(52) U.S. Cl. CPC H01M 10/0567; H01M 10/0525
USPC 429/188

(57) ABSTRACT

A nonaqueous electrolyte rechargeable battery includes a positive electrode, a negative electrode and a nonaqueous electrolyte. The nonaqueous electrolyte contains a film forming agent, and at least two films are formed in layers at least at a part of a surface of the negative electrode in accordance with charging and discharging of the nonaqueous electrolyte rechargeable battery. The film forming agent includes at least one kind of lithium salt having an oxalate complex. Among the at least two films, an innermost film is an oxalate complex-derived film that is derived from the oxalate complex and has a thickness equal to or greater than a film formed on an outer side of the innermost film. The film forming agent includes a compound having a LUMO level higher than the lithium salt incorporated in the oxalate complex-derived film as a high LUMO film forming agent.

### CROSS REFERENCE TO RELATED APPLICATION

This application is based on Japanese Patent Application No. 2012-213034 filed on Sep. 26, 2012, the disclosure of which is incorporated herein by reference.

### TECHNICAL FIELD

The present disclosure relates to a nonaqueous electrolyte rechargeable battery as an electric storage device, which outputs high power and has a high energy density and excellent charging and discharging cycle characteristics.

### BACKGROUND

With rapid market expansion of portable electronic devices, such as a laptop computer and a cell phone, demands of small-sized high capacity rechargeable batteries with a high energy density and excellent charging and discharging cycle characteristics have been increased for use in threes electric devices. In order to meet such demands, nonaqueous electrolyte rechargeable batteries have been developed. A nonaqueous electrolyte rechargeable battery uses alkali metal ions, such as lithium ions, as a charge carrier, and causes an electrochemical reaction in accordance with reception of charged particles of the charge carrier.

With regard to a nonaqueous electrolyte rechargeable battery used for vehicles, such as electric vehicles, higher durability performance has been required to meet with the expected lifetime of the vehicles.

In a nonaqueous electrolyte rechargeable battery, if an irreversible reaction as a side reaction, such as incorporation of lithium into a film when the film is formed, advances in addition to a regular battery reaction occurring during charging and discharging, the amount of lithium that can contribute to the battery reaction decreases. The decrease in the amount of lithium results in deterioration of a charging and discharging capacity.

As conventional techniques for improving the durability of rechargeable batteries, for example, JP2006-216378A, which corresponds to US 2012/0301760 A1, discloses (a) to add 0.1% by mass to 2% by mass of one or more kinds of compounds selected from a group consisting of LiBF₄, LiFOB, and LiBOB to an electrolyte, or (b) to add 0.01% by mass to 0.1% by mass of LiBF₄ and 0.1% by mass to 4% by mass of an aromatic compound to an electrolyte.

Also, JP 2006-196250 A, which corresponds to U.S. Pat. No. 7,416,813 B2, discloses to add a film forming agent made of at least one selected from a group consisting of lithium salt having an oxalate complex as anion, vinylene carbonate, vinyl ethylene carbonate, ethylene sulfite, and fluoro ethylene carbonate.

In the rechargeable battery disclosed in JP2006-216378A, it is difficult to sufficiently achieve an effect of suppressing the degradation of capacity. Also, in regard to the aromatic compound, oxide at a positive electrode is likely to be incorporated in the film. In such a case, an internal resistance is likely to increase. In the rechargeable battery disclosed in JP2006-196250A, it is difficult to sufficiently achieve the effect.

### SUMMARY

It is an object of the present disclosure to provide a nonaqueous electrolyte rechargeable battery which is capable of suppressing the decrease of the capacity and the increase in internal resistance.

According to an aspect of the present disclosure, a nonaqueous electrolyte rechargeable battery includes a positive electrode, a negative electrode and a nonaqueous electrolyte. The positive electrode and the negative electrode occluding and discharging lithium ions. The nonaqueous electrolyte contains a film forming agent including at least two kinds of compounds. In the nonaqueous electrolyte rechargeable battery, at least two films are formed in layers at least at a part of the surface of the negative electrode according to charging and discharging of the nonaqueous electrolyte rechargeable battery. The at least two kinds of compounds of the film forming agent include a lithium salt having an oxalate complex. Among the films, an innermost film is an oxalate complex-derived film derived from the oxalate complex of the lithium salt and has a thickness equal to or greater than the film disposed on an outer side of the innermost film. Further, the at least two kinds of compounds of the film forming agent include a compound having a LUMO level higher than that of the lithium salt incorporated into the oxalate complex-derived film as a high LUMO film forming agent.

Since the oxalate complex-derived film is formed, conductivity of the lithium ions is improved. Also, the film forming agent contains the compound having the LUMO level higher than that of the compound having the oxalate complex forming the oxalate complex-derived film, and the compound having the higher LUMO level forms the film on the outer side of the oxalate complex-derived film. Therefore, the performance of the oxalate complex-derived film is protected by the film formed on the outer side of the oxalate complex-derived film.

### BRIEF DESCRIPTION OF THE DRAWINGS

The above and other objects, features and advantages of the present disclosure will become more apparent from the following detailed description made with reference to the accompanying drawings, in which:

FIG. 1 is a chart illustrating characteristics of test batteries according to an embodiment of the present disclosure; and

FIG. 2 is a chart illustrating characteristics of test batteries according to the embodiment of the present disclosure.

### DETAILED DESCRIPTION

In a nonaqueous electrolyte rechargeable battery, consumption of lithium due to an irreversible reaction results in the reduction of the charging and discharging capacity. The inventors of the present disclosure found a means of suppressing the consumption of lithium due to the irreversible reaction.

In particular, the inventors found that, when a film (oxalate complex-derived film) derived from an oxalate complex is formed on a surface of a negative electrode and a film made of a compound having a lowest unoccupied molecular orbital (LUMO) level higher than that of the oxalate complex forming the oxalate complex-derived film is formed on an outer side of the oxalate complex-derived film, conductivity of the lithium ion improves and durability of the oxalate complex-derived film improves. Namely, the conductivity of the lithium ion is kept at a higher level by the oxalate complex-derived film, and a performance of the oxalate complex-derived film can be maintained by the film formed on the outer side of the oxalate complex-derived film.

The compound having the LUMO level higher than the oxalate complex forms the film on the negative electrode after the oxalate complex forms the oxalate complex-derived film. That is, the compound having the LUMO level higher than the oxalate complex forms the film on the outer side of the oxalate complex-derived film.

In a case where the oxalate complex-derived film is used to a negative electrode having a surface made of a low crystalline carbon (derived from pitch), the oxalate complex-derived film effectively covers small pores of the low crystalline carbon. Since a specific surface area is reduced, the decrease of capacity is suppressed.

(i) Based on the above findings, the following nonaqueous electrolyte rechargeable battery was made. The nonaqueous electrolyte rechargeable battery includes a positive electrode and a negative electrode which occlude and discharge lithium ions, and a nonaqueous electrolyte. The nonaqueous electrolyte contains a film forming agent including two or more kinds of compounds. In the nonaqueous electrolyte rechargeable battery, at least two films are formed in layers at least at a part of the surface of the negative electrode according to charging and discharging of the nonaqueous electrolyte rechargeable battery. The film forming agent includes at least one kind of a lithium salt having an oxalate complex. Among the films, an innermost film is an oxalate complex-derived film that is derived from the oxalate complex and has a thickness equal to or greater than a film disposed on an outer side of the innermost film. The film forming agent includes a compound, as a high LUMO film forming agent, that has a LUMO level higher than that of the compound incorporated in the innermost film.

The oxalate complex-derived film, which is derived from the oxalate complex of the lithium salt, is made as a result of the oxalate complex reacting in a charging and discharging reaction. For example, the oxalate complex-derived film may be formed as a result of a decomposed product or the oxalate complex itself polymerizing or bonding one another.

The nonaqueous electrolyte rechargeable battery may be implemented by further employing one or more of the following features (ii) to (vii) in any combination.

(ii) The innermost film has a thickness of equal to or greater than 5 nm and equal to or less than 20 nm. When the thickness of the innermost film is in this range, the degradation of the capacity and the increase of the internal resistance can be suppressed.

(iii) The lithium salt having the oxalate complex is one or more of compounds selected from a group consisting of compounds expressed by the following formulas (1) to (4). When the lithium salt is selected from these compounds, the degradation of the capacity is sufficiently suppressed.

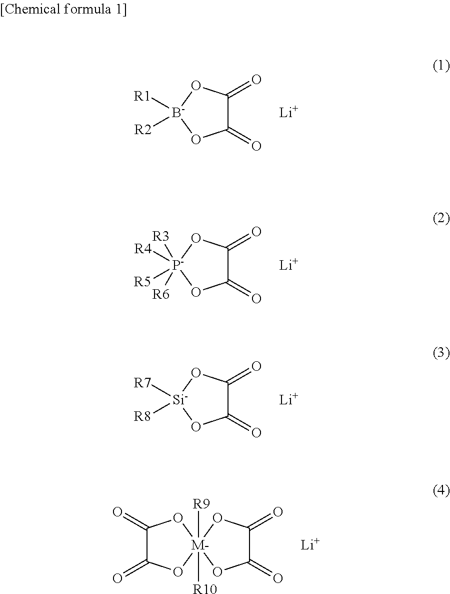

In the formulas (1) to (4), each of R1 to R10 represents an alkyl group, fluorine, bromine, or chlorine. In the formula (4), M represents boron (B), phosphorous (P) or silicon (Si). In a case where M is boron or silicon, R9 and R10 do not exist.

(iv) The content of the lithium salt having the oxalate complex is from 0.3% to 1.5% of a total mass of the nonaqueous electrolyte. When the content of the oxalate complex is in this range, an oxalate complex-derived film exerting an appropriate function can be formed.

(v) The film forming agent contains at least one compound selected from a group consisting of compounds expressed by the following formulas (5) to (24). In the formula (17), Ph represents a phenyl group. When the film forming agent contains at least one of these compounds, films including the oxalate complex-derived film can be appropriately formed on the surface of the negative electrode. That is, when the film forming agent contains at least one of these compounds, the oxalate complex-derived film is formed and the film is formed on the outer side of the oxalate complex-derived film. The oxalate complex-derived film is sufficiently protected by the film formed on the outer side of the oxalate complex-derived film.

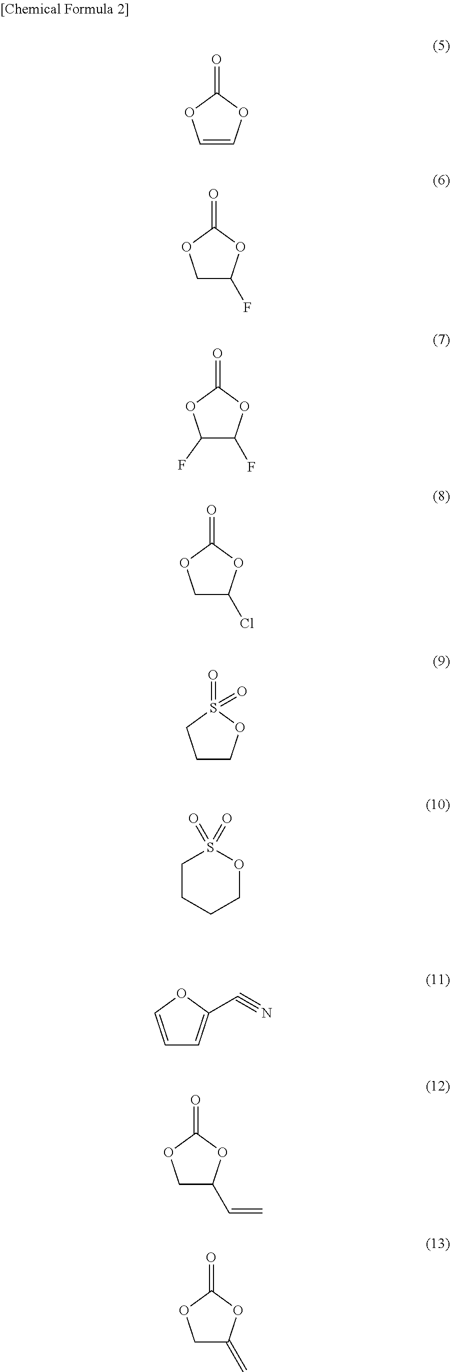

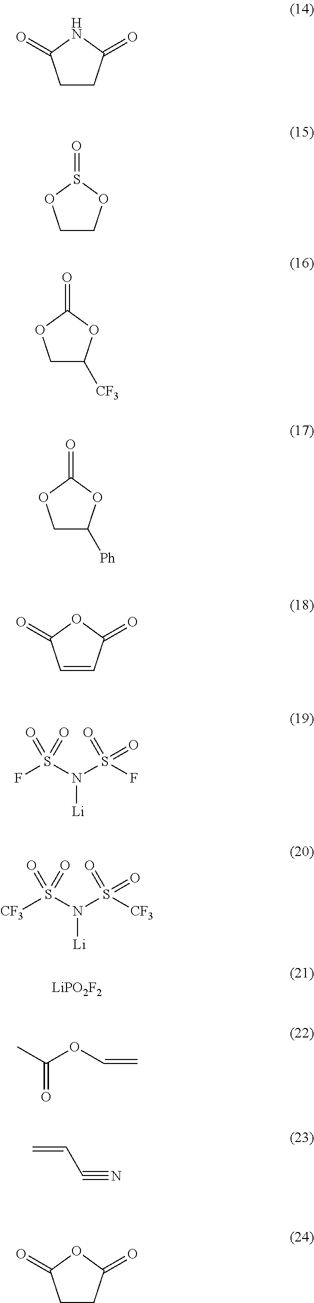

(vi) The content of the compound constituting the high LUMO film forming agent is equal to or higher than 0.3% of a total mass of the nonaqueous electrolyte. When the content of the high LUMO film forming agent is in this range, the film for protecting the oxalate complex-derived film can be appropriately formed.

(vii) The positive electrode contains a compound having an olivine structure. The positive electrode having the olivine structure is stable, and it is less likely that the oxalate complex-derived film will be damaged by an elution of components from the positive electrode. Therefore, durability of the nonaqueous electrolyte rechargeable battery improves.

The nonaqueous electrolyte rechargeable battery of the present disclosure will be described more in detail with reference to the following embodiment.

According to an embodiment, a nonaqueous electrolyte rechargeable battery includes a positive electrode, a negative electrode, a nonaqueous electrolyte, and a film forming agent. The nonaqueous electrolyte rechargeable battery may include any other necessary members, which are selected as appropriate.

The film forming agent may be dissolved in the nonaqueous electrolyte, or disposed on or at a proximity of a surface of the negative electrode. The film forming agent may be applied to or adhered to the surface of the negative electrode.

The film forming agent forms films on the surface of the negative electrode in accordance with a charging and discharging reaction in the battery. The charging and discharging reaction may be conducted in a conditioning process of the battery, for example.

The film forming agent contains two or more kinds of compounds having different LUMO levels. At least one of the compounds of the film forming agent is an oxalate complex, preferably, a lithium salt having an oxalate complex.

The film forming agent forms at least two layered films at least at a part of the surface of the negative electrode in accordance with the reaction in the battery. At least at part of the films contains a component, such as a discomposed product, derived from the oxalate complex. For example, the films include at least one film derived from the oxalate complex. The film containing the compound derived from the oxalate complex is referred to as an oxalate complex-derived film.

Among oxalate complex-derived films, an innermost film disposed a an innermost layer has a thickness greater than a thickness of the film disposed on an outer side of the innermost film. The innermost film does not correspond to an outermost layer of the films formed by the film forming agent.

Among the compounds contained in the film forming agent, the compound incorporated into the film disposed outside than the innermost film includes a compound (high LUMO film forming agent) that has the LUMO level higher than the oxalate complex incorporated into the innermost film.

The thickness of the films formed on the negative electrode is measured by a depth profiling using an X-ray photoelectron spectroscopy (XPS). In particular, the thickness of the film is calculated based on the change in content of a carbon atom. In a case where the film forming agent contains boron (B), the thickness of the film is measured also considering the content of the boron.

The thickness of the film may be controlled according to the additive amount of the film forming agent. Also, the thickness of the film may be restricted by an electrochemical limit. That is, when the films are formed on the surface of the negative electrode with some thickness, a film formation reaction will not advance any more. When the film forming reaction stops, the surplus film forming agent will remain in the nonaqueous electrolyte. Among the compounds contained in the film forming agent, the compound(s) remaining in the nonaqueous electrolyte can function as a supporting salt of the nonaqueous electrolyte depending on the kind of the compound(s). For example, the oxalate complex can function as the supporting salt when added as the lithium salt.

The oxalate complex is preferably one or more selected from a group consisting of compounds expressed by the above-described formulas (1) to (4). Preferably, the oxalate complex is selected from the following compounds (25) to (29). The LUMO level of the compound (25) (i.e., LiBOB) is −1.68. The LUMO level of the compound (26) (i.e., LiFOB) is −0.77. The LUMO level of the compound (27) (i.e., LiPFO) is −3.23. The LUMO level of the compound (28) (i.e., LiFOP) is −2.52. The LUMO level of the compound (29) (i.e., lithium bis oxalate silane) is −3.44. In the present disclosure, the LUMO level is calculated using WinMOPAC 3.9 (parameter PM5) of Fujitsu Ltd.

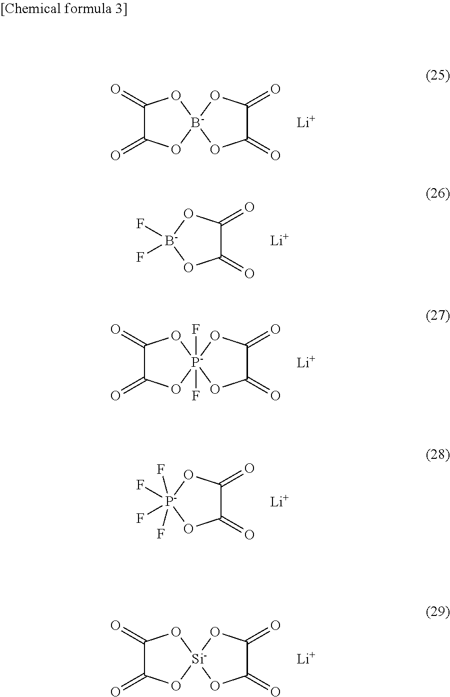

The high LUMO film forming agent is preferably selected from the above-described compounds (5) to (24).

The LUMO level of the compound (5) (i.e., VC) is −1.03. The LUMO level of the compound (6) (i.e., FEC) is −1.25. The LUMO level of the compound (7) (i.e., DFEC) is −1.68. The LUMO level of the compound (8) (i.e., CIEC) is −1.26. The LUMO level of the compound (9) (i.e., 1,3-PS) is −1.50. The LUMO level of the compound (10) (i.e., 1,4-BS) is −1.51. The LUMO level of the compound (11) (i.e., CN—F) is −0.60. The LUMO level of the compound (12) (i.e., VEC) is −0.95. The LUMO level of the compound (13) is −0.89. The LUMO level of the compound (14) is −0.71. The LUMO level of the compound (15) (i.e., PS) is −1.38. The LUMO level of the compound (16) (i.e., TFPC) is −1.65. The LUMO level of the compound (17) (i.e., PhEC) is −0.71. The LUMO level of the compound (18) (i.e., MA) is −2.16. The LUMO level of the compound (19) (i.e., LiFSI) is −1.40. The LUMO level of the compound (20) (i.e., LiTFSI) is −2.29. The LUMO level of the compound (21) (LiPO₂F₂) is −1.38. The LUMO level of the compound (22) (i.e., VA) is −0.12. The LUMO level of the compound (23) (i.e., ANN) is −0.07. The LUMO level of the compound (24) is −0.71.

When the battery containing the film forming agent is charged or discharged, the films are formed on the surface of the negative electrode. In this application, the charging and discharging includes a conditioning process of the battery. That is, the films may be formed by the conditioning process.

The positive electrode includes at least a positive-electrode active material that can discharge lithium ions during charging and occlude the lithium ions during discharging. Material composition of the positive electrode is not particularly limited, and the positive electrode may have known material composition. For example, the positive electrode is provided by a structure in which an active material layer is formed on a collector. The active material layer is formed by depositing a mixture of a positive-electrode active material, a conductive material and a binder on the collector.

The positive-electrode active material is not limited to a specific one, but includes a lithium-containing transition metal oxide, for example. The lithium-containing transition metal oxide is a material into and from which Li⁺ ions can be inserted and desorbed. For example, the lithium-containing transition metal oxide is a lithium-metal composite oxide having an olivine structure, a layered structure or a spinel structure.

Examples of the lithium-metal composite oxide are Li_{1-z}MPO₄ (M is iron, manganese or a composite body thereof), Li_{1-z}NiO₂, Li_{1-z}MnO₂, Li_{1-z}Mn₂O₄, Li₁₋zCoO₂, Li_{1-z}CoₓMn_{y}Ni_{(1-x-y)}O₂, and the like, and the positive-electrode active material may contain one or more elements selected from these examples. In these examples, z is the number equal to or greater than 0 and less than 1, and x and y are numbers equal to or greater than 0 and equal to or less than 1. In these examples, Li, Mg, Al, or a transition metal, such as Co, Ti, Nb, or Cr, may be added to or substituted for each element. Such a lithium-metal composite oxide may be independently used. Alternatively, a plurality of kinds of these oxides may be mixed and used together. Further, a conductive polymer material or a material having radicals may also be mixed.

The positive-electrode active material is preferably a lithium and transitional metal composite oxide, such as LiFePO₄, LiMnPO₄, LiFeMnPO₄, LiMn₂O₄, LiCoO₂, and LiNiO₂. In these cases, the positive-electrode active material has favorable properties as an active material, such as having a favorable diffusion property of electrons and lithium ions, and hence a rechargeable battery having high charging and discharging efficiency and favorable cycle characteristics can be achieved. In particular, the positive-electrode active material is preferably LiFePO₄.

The binder of the positive electrode serves to bind, active material particles. As the binder of the positive electrode, for example, an organic binder and an inorganic binder are used. Examples of the binder of the positive electrode are compounds, such as polyvinylidene fluoride (PVDF), polyvinylidene chloride, polytetrafluoroethylene (PTFE), carboxymethyl cellulose, and the like.

The conductive material of the positive electrode serves to maintain an electric conductivity of the positive electrode. For example, the conductive material is one of or mixture of carbon substances, such as carbon black, acetylene black (AB), and graphite.

The collector of the positive electrode is, for example, provided by a processed metal of such as aluminum or stainless steel. For example, the collector of the positive electrode has a foil shape, plate shape, net shape or the like. Further, the collector of the positive electrode is provided by a punched metal, a form metal or the like.

The negative electrode includes a negative electrode active material that can occlude lithium ions during the charging and discharge the lithium ions during the discharging. Examples of the negative electrode active material are a metallic lithium, an alloy base material, a carbon base material and the like. The material composition of the negative electrode active material is not limited to specific one, but may be any known composite material. For example, the negative electrode has a structure in which an active material layer is formed on a collector. The active material layer is formed by depositing a mixture of the negative electrode active material and a binder on a collector.

As the negative electrode active material, a carbon material, in particular, a low crystalline carbon material, such as a carbon material derived from pitch, is preferably used in view of the increase in capacity and output. The surface of the negative electrode active material is preferably formed of a low crystalline carbon material. In the present embodiment, even when the negative electrode active material is made of the low crystalline carbon material, since the oxalate complex-derived film, which contributes to improve battery performance, is formed, durability is improved. That is, the decrease in capacity is suppressed.

As an example, the alloy base material is used for a part of or the whole of the negative electrode material. The alloy base material is a material that is capable of occluding or desorbing a lithium element, or dissolving or separating a lithium element in accordance with the advance of the battery reaction. The alloy base material is a material that allows alloying, compounding, dealloying and decompounding of the lithium element. In the present disclosure, the alloying and the compounding will be both referred to as the alloying, and the dealloying and decompounding will be both referred to as the decompounding. Further, “alloy” means a material made of two or more metal elements, and a compound made of one or more metal elements and one or more metalloid elements. The formation of the alloy base material includes a solid solution, an eutectic (eutectic mixture), an intermetallic compound, and a material in which two or more of the solid solution, the eutectic and the intermetallic compound coexist.

Examples of the metal elements and the metalloid elements are magnesium (Mg), gallium (Ga), aluminum (Al), silicon (Si), germanium (Ge), tin (Sn), lead (Pb), arsenic (As), antimony (Sb), bismuth (Bi), silver (Ag), gold (Au), zinc (Zn), cadmium (Cd), mercury (Hg), copper (Cu), vanadium (V), indium (In), boron (B), zirconium (Zr), yttrium (Y) and hafnium (Hf). In the embodiment, the alloy base material may contain at least one of these elements as a simple substance or the alloy.

Preferably, the alloy base material contains the metal element of IVB group or the metalloid element in a short period-type periodic table as the simple substance or the alloy. More preferably, the alloy base material contains silicon (Si) or tin (Sn), or the alloy of silicon and tin. These elements may be crystalline or amorphous.

Further examples of the negative electrode material, which occludes and discharges lithium, are an oxide, a sulfide, and other metallic compounds such as lithium nitrides (e.g., LiN₃). Example of the oxide are MnO₂, V₂O₅, V₆O₁₃, NiS, MoS and the like. Further examples of the oxide, which occludes and discharges lithium though has a relatively low electric potential, are iron oxide, ruthenium oxide, molybdenum oxide, tungstic oxide, titanium oxide, tin oxide and the like. Examples of the sulfide are NiS, MoS and the like.

The binder of the negative electrode serves to bind the active material particles. As the binder of the negative electrode, for example, an organic binder and an inorganic binder are used. Examples of the binder of the negative electrode are compounds, such as polyvinylidene fluoride (PVDF), polyvinylidene chloride, polytetrafluoroethylene (PTFE), styrene butadiene rubber (SBR), polyimide (PI), carboxymethyl cellulose, and the like.

The collector of the negative electrode is, for example, provided by a processed metal of such as copper and nickel. For example, the collector of the negative electrode has a foil shape, plate shape, net shape or the like. As other examples, the collector of the negative electrode is provided by a punched metal, a form metal or the like.

The nonaqueous electrolyte may have any formation, such as a liquid state and a gel state. Examples of the liquid state nonaqueous electrolyte are a solution containing a supporting salt and an organic solvent for dissolving the supporting salt, an ionic solution and the like. Examples of the organic solvent are ethylene carbonate (EC), propylene carbonate (PC), dimethyl carbonate (DMC), ethylmethyl carbonate (EMC), and diethyl carbonate (DEC). These examples of the organic solvent have a high oxidative degradation potential, such as 4.3 V or more, and thus contribute to improve the stability of the nonaqueous electrolyte rechargeable battery when being used as the solvent of the nonaqueous electrolyte.

In addition to the examples described above, an organic solvent that is generally used for an electrolyte solution of a nonaqueous electrolyte rechargeable battery may be used. For example, carbonates other than the above described carbonates, a halogenated hydrocarbon, ethers, ketones, nitrides, lactones, oxolane compounds, and the like may be used. In particular, a propylene carbonate, an ethylene carbonate, 1,2-dimethoxyethane, dimethyl carbonate, diethyl carbonate, ethylmethyl carbonate, vinylene carbonate (VC), and a mixture of these solvents may be used. When the supporting salt is dissolved in these solvents, these solvents can serve as the electrolyte.

The supporting salt is not limited to a specific one. Examples of the supporting salt are salt compounds, such as LiPF₆, LIBF₄, LiAsF₆, LiCF₃SO₃, LiN(CF₃SO₂)₂, LiC(CF₃SO₂)₃, LiSbF₆, LiSCN, LiClO₄, LiAlCl₄, NaClO₄, NaBF₄, NaI, and a derivative thereof. Of these examples, one or more kinds of salts selected from the group consisting of LiPF₆, LiBF₄, LiClO₄, LiAsF₆, LiCF₃SO₃, LiN(CF₃SO₂)₂, LiC(CF₃SO₂)₃, LiN(FSO₂)₂, LiN(CF₃SO₂) (C₄F₃SO₂), a derivative of LiCF₃SO₃, a derivative of LiN(CF₃SO₂)₂, and a derivative of LiC(CF₃SO₂)₃ are exemplarily used in view of electric characteristics.

As the supporting salt, an oxalate complex can be added to the solution. As the oxalate complex, the examples described above as the film forming agent can be added. Examples of the oxalate complex are lithium bis(oxalate) borate (LiBOB), lithium difluoro(oxalate) borate (LiFOB), lithium difluorobis(oxalate)phosphate, lithium bis(oxalate)silane, and complexes expressed in the following chemical formula 4.

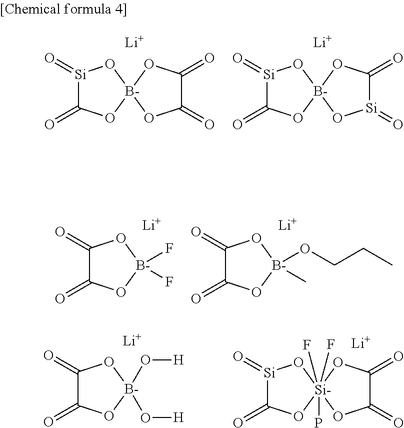

These compounds can also function as the film forming agent depending on a case, that is, depending on the compound contained in the nonaqueous electrolyte.

The nonaqueous electrolyte may be in a gel state by adding a gelatinizing agent.

In addition to or in place of the supporting salt and organic solvent described above, an ionic solution, which can be used for the nonaqueous electrolyte rechargeable battery, may be used. Examples of a cation component of the ionic solution are an N-methyl-N-propylpiperidinium, a dimethyl-ethyl methoxy ammonium cation, and the like. Examples of an anion component of the ionic solution are BF⁴⁻, N(SO₂CF₃)²⁻, and the like.

In addition to the positive electrode, the negative electrode and the nonaqueous electrolyte, the nonaqueous electrolyte rechargeable battery may include any other member, if necessary, such as a separator and a case. The separator is disposed between the positive electrode and the negative electrode. The separator provides functions of electric insulation and ionic conduction. In a case where the nonaqueous electrolyte is in the liquid state, the separator serves to hold the nonaqueous electrolyte.

The separator may be provided by a porous synthetic resin film. An example of the porous synthetic resin film is a porous film of a polyolefin base macromolecule, such as polyethylene and polypropylene. Further, the size of the separator is preferably greater than an area of the positive electrode and the negative electrode in order to maintain insulation between the positive electrode and the negative electrode.

### EXAMPLES

The nonaqueous electrolyte rechargeable battery of the embodiment will be hereinafter described in detail based on the following examples.

(Consideration of Film Forming Agent)

<Fabrication of Test Batteries>

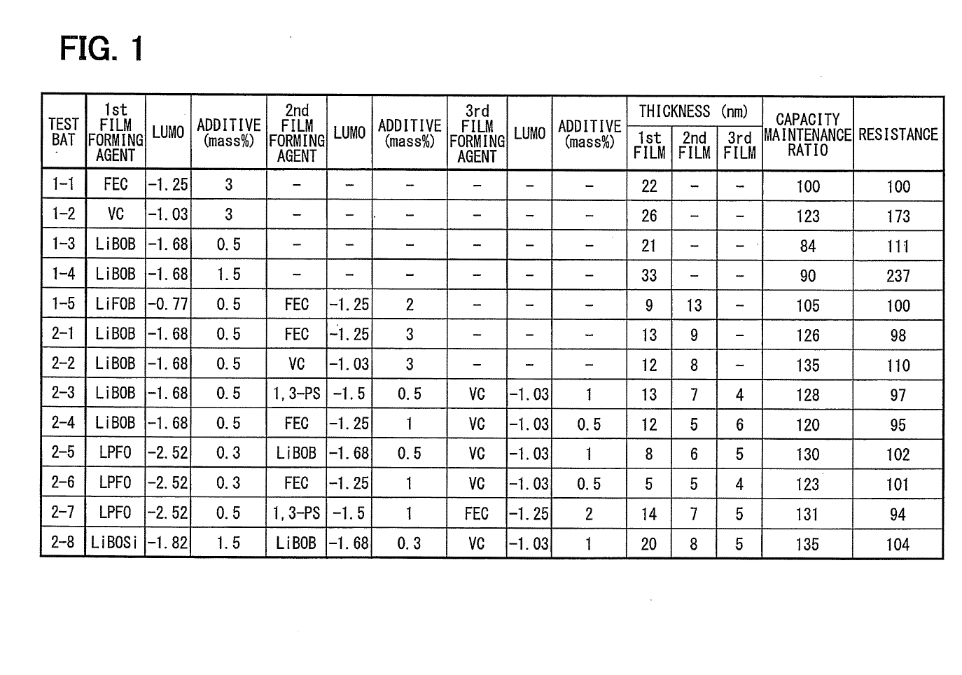

As test examples, test batteries 1-1 to 1-5 and 2-1 to 2-8 were prepared. Each of the test batteries 1-1 to 1-5 and 2-1 to 2-8 was prepared by employing components shown in a chart of FIG. 1.

A manufacturing method of the test battery 1-1 will be described hereinafter as an example. The other test batteries 1-2 to 1-5 and 2-1 to 2-8 were prepared in the similar manner.

The test battery 1-1 is a lithium rechargeable battery using a lithium composite oxide represented by a composition formula of LiFePO₄ as a positive electrode active material and a graphite as a negative electrode active material.

A positive electrode was manufactured in the following manner.

First, 80 parts by mass of the positive electrode active material described above, 10 parts by mass of acetylene black (AB) as a conductive material, and 10 parts by mass of polyvinylidene difluoride (PVDF) as a binder were mixed together, and an appropriate amount of an N-methyl-2-pyrrolidone was added to this mixture. The mixture was kneaded. Thus, a paste-like positive electrode mixture was produced.

The positive electrode mixture was applied to both sides of a positive-electrode collector made of an aluminum foil with a thickness of 15 micrometers (μm), dried and processed by pressing, so a sheet-like positive electrode was produced. The sheet-like positive electrode was cut into a band shape to produce a positive electrode plate. Further, the positive electrode mixture was scratched from a part of the positive electrode plate, and a positive electrode battery lead was joined to the scratched portion of the positive electrode plate.

A negative electrode was manufactured in the following manner. First, 98 parts by mass of a graphite, 1 part by mass of carboxymethyl cellulose (CMC) as a binder and 1 part by mass of styrene butadiene rubber (SBR) as a binder were mixed together. Further, an appropriate amount of an N-methyl-2-pyrrolidone was added to this mixture and kneaded. Thus, a paste-like negative electrode mixture was produced.

The negative electrode mixture was applied to both sides of a negative-electrode collector made of a copper foil with a thickness of 10 μm, dried and processed by pressing, so a sheet-like negative electrode was produced. The sheet-like negative electrode was cut into a band shape to produce a negative electrode plate. The negative electrode mixture was scratched from a part of the negative electrode plate, and a negative electrode battery lead was joined to the scratched portion of the negative electrode plate.

A separator was interposed between the positive electrode plate and the negative electrode plate to form a stacked body. The stacked body of the positive electrode plate and the negative electrode plate between which the separator is interposed was wound to form a flat wound-type electrode body (capacity: 5 Ah). The outer perimeter of the electrode body was wrapped with the separator to keep insulation from a periphery.

A nonaqueous electrolyte was produced in the following manner.

First, EC, DMC and EMC were mixed at a ratio of 30:30:40 (volumetric basis) to form a mixed solvent. Then, 12 mass % of LiPF₆ was dissolved in the mixed solvent. In the nonaqueous electrolyte, as the film forming agent, compounds (first to third film forming agents) were added with the amounts shown in the chart of FIG. 1. The compounds added as the film forming agents are designated to the first to third film coating agents in an incrementing order of the LUMO level. That is, the first film forming agent has the lowest LUMO level, and the third film forming agent has the highest LUMO level.

The other test batteries 1-2 to 1-5 and 2-1 to 2-8 were manufactured in the similar manner, except that the compositions are different.

After the test batteries were manufactured, a conditioning process was carried out for each of the test batteries. In the conditioning process, after the nonaqueous electrolyte was inserted, a charging and discharging was performed for two cycles, one cycle including a constant current and constant voltage (CC-CV) charging (4.0 V, ¼ C,) and a constant current (CC) discharging (2 V, ¼ C). Then, the test batteries were held under 60 degrees Celsius (° C.) for 36 hours.

By this conditioning process, a film was formed on the surface of the negative electrode. The thickness of the film was measured by the XPS and shown in the chart of FIG. 1. In a case where a plurality of compounds was contained as the film forming agent, which compound was incorporated into which film was determined by evaluating while focusing on the element (e.g., B) contained in the compound.

<Cycle Test (Durability Characteristics Evaluation)>

After the conditioning of each of the test batteries, a charging and discharging was performed for 90 cycles at an ambient temperature of 60 degrees Celsius (° C.), one cycle including a constant current and constant voltage (CC-CV) charging (1 C, 3.6 V) and a constant current (CC) discharging (1C, to 2.6 V). A capacity maintenance ratio to the first charging capacity (initial capacity) was calculated. The capacity maintenance ratio of the test battery 1-1 is defined as 100, and the capacity maintenance ratio of each test battery is calculated as a value relative to the capacity maintenance ratio of the test battery 1-1. The results are shown in the chart of FIG. 1. The higher capacity maintenance ratio indicates a higher durability characteristic.

<Output Characteristic Test>

When the state of charge (SOC) is 60%, the discharging was performed at each of discharge rates 1 C, 2 C, 3 C, 5 C and 10 C. Further, a gradient of voltage after ten seconds elapsed from the time before the discharging is begun was calculated in each case, and an internal resistance was measured based on the gradient of voltage calculated. As a measurement condition, the ambient temperature was 25° C. The internal resistance of the test battery 1-1 was defined as 100, and the internal resistance of each test battery was calculated as a value relative to the internal resistance of the test battery 1-1. The results are shown in the chart of FIG. 1. The smaller internal resistance indicates a higher output characteristic.

As shown in the chart of FIG. 1, each of the test batteries 1-1 to 1-4 contains only one kind of the film forming agent. Each of the test batteries 2-1 to 2-8 contains two or more kinds of the film forming agents. In each of the test batteries 2-1 to 2-8, a film derived from the higher LUMO film forming agent is formed on an outer side than the oxalate complex-derived film. Therefore, each of the test batteries 1-1 to 1-4 has a lower capacity maintenance ratio and/or much higher resistance than those of the test batteries 2-1 to 2-8.

Among the test batteries 1-1 to 1-5, the test battery 1-2, which includes only the VC as the film forming agent, has the capacity maintenance ratio similar to those of the test batteries 2-1 to 2-8. However, the resistance of the test battery 1-2 is very high, such as 173, and thus the test battery 1-2 will not be practical.

When the test battery 1-1 and the test battery 2-1, which contains the LiBOB in addition to the FEC, are compared, it is appreciated that the capacity maintenance ratio can be increased without increasing the resistance by adding the LiBOB. When the test battery 1-2 and the test battery 2-2, which contains the LiBOB in addition to the VC, it is appreciated that the resistance can be greatly reduced without reducing the capacity maintenance ratio by adding the LiBOB.

When the test battery 1-3 and the test battery 1-4 are compared, it is appreciated that, by increasing the additive amount of the LiBOB from 0.5% to 1.5%, the resistance largely increases, though the capacity maintenance ratio improves.

In the test batteries 2-1 to 2-4 in which the high LUMO film forming agent having the higher LUMO level is added in addition to the LiBOB, the capacity maintenance ratio greatly increases and the resistance is at a similar level (e.g., test battery 2-2) or greatly reduced. Therefore, it is appreciated that it is effective to use the high LUMO film forming agent together with the oxalate complex.

When the test battery 2-4 and the test battery 2-8 are compared, it is appreciated that the resistance can be reduced by adding LiBOSi, which has the LUMO level smaller than the LiBOB. This reason is considered because the film derived from the LiBOSi is formed on the inner side of the film derived from the LiBOB. The film derived from the LiBOSi can contribute to further reduce the resistance value.

<Consideration of Material of Positive Electrode>

As test batteries 1-6 to 1-8, rechargeable batteries which correspond to the test batteries 2-2 and 2-3, but the kinds of the positive electrode active material is different were produced. As the positive electrode active material, LiMn₂O₄ (LMO), LiNi_{0.5}Mn_{0.5}O (LNMO) and LiFePO₄ (LFPO) were used.

The test batteries 1-7 to 1-9 use the same positive electrode active material, that is, LNMO. In regard to the test batteries 1-8 and 1-9, the compositions were the same, but only a condition of the conditioning process was different.

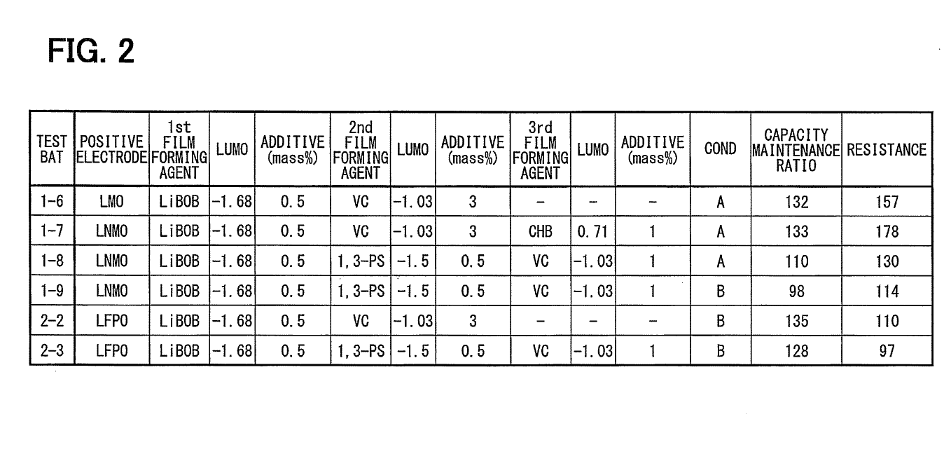

In particular, the conditioning process of the test batteries 1-7 and 1-8 was performed under a condition A, in place of a condition B which was employed to the test batteries 1-1 to 1-5 and 2-1 to 2-8. In the condition A, the CC-CV charging is performed at 4.2 V and ¼ C. In the condition B, the CC-CV charging is performed at 4.0 V and ¼ C. In the condition A, the voltage of the charging is higher than that of the condition B to correspond to an actual potential when the test batteries containing these positive electrode active materials are used. The potential corresponds to a potential where the lithium element is sufficiently and deeply incorporated to the negative electrode active material. If the potential is low, the lithium element is less likely to be deeply incorporated into the negative electrode active material. In regard to the test battery 1-6, the conditioning process was performed under the condition A. The capacity maintenance ratio and the resistance of these test batteries were measured in the conditions described above. The measurement results are shown the chart of FIG. 2.

As shown in the chart of FIG. 2, when the results of the test batteries 1-8, 1-9 and 2-3 are compared, since the conditioning of the test battery 1-9 was not performed in the sufficient condition, the film was not sufficiently formed. Therefore, the test battery 1-9 cannot exert sufficient battery performance (capacity maintenance ratio). On the other hand, in the test battery 1-8, the conditioning of which was performed in the sufficient condition. As a result, although the capacity maintenance ratio was increased, the resistance was greatly increased. This reason is considered because, when the voltage reaches 4.2 V in the charging, decomposition of LiBOB is advanced in the positive electrode due to a decomposition voltage of the LiBOB being relatively low, and thus the film is not formed selectively in the negative electrode. This can be also appreciated from a comparison between the test battery 1-6 which uses the LMO in the positive electrode and the test battery 2-2 corresponding to the test battery 1-6.

While only the selected exemplary embodiment has been chosen to illustrate the present disclosure, it will be apparent to those skilled in the art from this disclosure that various changes and modifications can be made therein without departing from the scope of the disclosure as defined, in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A nonaqueous electrolyte rechargeable battery comprising:
a positive electrode and a negative electrode occluding and discharging lithium ions; and
a nonaqueous electrolyte, wherein
the nonaqueous electrolyte contains a film forming agent,
the film forming agent includes at least two kinds of compounds, and forms at least two films in layers at least at a part of a surface of the negative electrode in accordance with charging and discharging of the nonaqueous electrolyte rechargeable battery,
the at least two kinds of compounds of the film forming agent include at least one kind of lithium salt having an oxalate complex,
among the at least two films, an innermost film is an oxalate complex-derived film that is derived from the oxalate complex and has a thickness equal to or greater than a film formed on an outer side of the innermost film, and
the at least two kinds of compounds of the film forming agent include a compound having a LUMO level higher than that of the at least one kind of lithium salt incorporated in the oxalate complex-derived film as a high LUMO film forming agent.

2. The nonaqueous electrolyte rechargeable battery according to claim 1, wherein
the thickness of the oxalate complex-derived film is equal to or greater than 5 nm and equal to or less than 20 nm.

3. The nonaqueous electrolyte rechargeable battery according to claim 1,
wherein the at least one kind of lithium salt having the oxalate complex is selected from a group consisting of compounds expressed by following formulas (1) to (4), in which each of R1 to R10 is an alkyl group, fluorine, bromine, or chlorine, and M is boron, phosphorous or silicon, and in a case where M is boron or silicon, the formula (4) does not have R9 and R10,

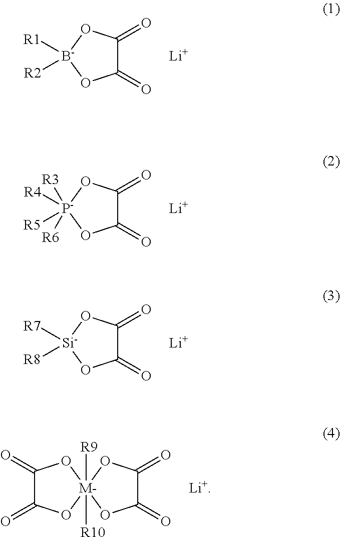

4. The nonaqueous electrolyte rechargeable battery according to claim 1, wherein
a content of the lithium salt having the oxalate complex is 0.3% to 1.5% of a total mass of the nonaqueous electrolyte.

5. The nonaqueous electrolyte rechargeable battery according to claim 1, wherein
the at least two kinds of compounds of the film forming agent include at least one selected from a group consisting of compounds expressed by following formulas (5) to (24),

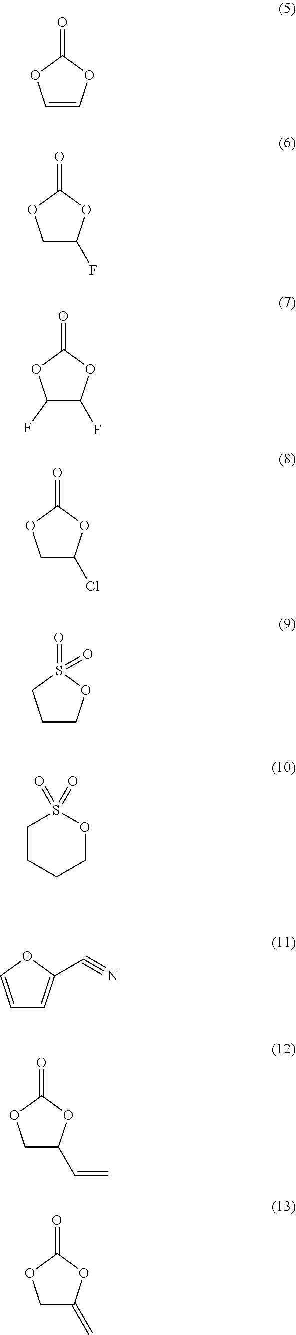

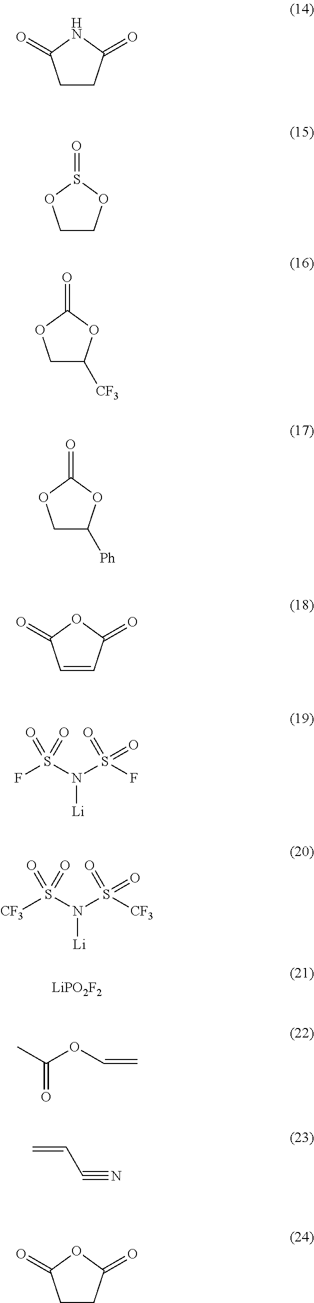

6. The nonaqueous electrolyte rechargeable battery according to claim 1, wherein
a content of the compound as the high LUMO film forming agent is equal to or greater than 0.3% of a total mass of the nonaqueous electrolyte.

7. The nonaqueous electrolyte rechargeable battery according to claim 1, wherein
the positive electrode contains a compound having an olivine structure.
